(19) United States
(12) Patent Application Publication
(10) Pub. No.: US 2009/0038818 A1
(43) Pub. Date: Feb. 12, 2009

(54) AUXILIARY HANDLE DEVICE

(76) Inventors: Roswitha Eicher, Filderstadt (DE); Stefan Heess, Leinfelden-Echterdingen (DE); Joerg Maute, Sindelfingen (DE); Florian Esenwein, Uhingen-Holzhausen (DE); Bernhard Eicher, Filderstadt (DE); Marcus Schuller, Dettenhausen (DE)

Correspondence Address: Striker, Striker & Stenby, 103 East Neck Road, Huntington, NY, 11743, US

(21) Appl. No.: 12/183,157

(22) Filed: Jul. 31, 2008

(30) Foreign Application Priority Data
Aug. 6, 2007 (DE) 10 2007 037 047.6

(51) Int. Cl. B25G 1/01; B24B 27/08

(52) U.S. Cl. 173/162.2; 16/431; 451/344

(57) ABSTRACT

An auxiliary handle device, in particular for a hand-held power tool, has an auxiliary handle and a damping unit. The damping unit includes a rotation unit with at least one rotation element, which is provided to rotate about at least one rotation axis.

### CROSS-REFERENCE TO A RELATED APPLICATION

The invention described and claimed hereinbelow is also described in German Patent Application DE 10 2007 037 047.6 filed on Aug. 6, 2007. This German Patent Application, whose subject matter is incorporated here by reference, provides the basis for a claim of priority of invention under 35 U.S.C. 119(a)-(d).

### BACKGROUND OF THE INVENTION

The present invention is directed to an auxiliary handle device.

An auxiliary handle device for a hand-held power with an auxiliary handle and a damping unit is already known.

### SUMMARY OF THE INVENTION

The present invention is directed to an auxiliary handle device, in particular for a hand-held power tool, with an auxiliary handle and a damping unit.

It is provided that the damping unit includes a rotation unit with at least one rotation element that is designed to rotate about at least one rotation axis. In this context, an “auxiliary handle” is understood to be a region and/or a component and/or an element provided for placement—and enclosing, in particular—by one or two hands of an operator for guiding a hand-held power tool using an auxiliary handle device, and which is capable of being attached to the hand-held power tool in an auxiliary manner, adjacent to a further handle, in particular the main handle, the auxiliary handle device being located on the side of the hand-held power tool, and/or being capable of being removed from the hand-held power tool by an operator without the use of tools, and/or being located in a front region of the hand-held power tool close to the tool, and/or the auxiliary handle is designed in the shape of a rod.

In addition, a “rotation unit” refers, in particular, to a unit that includes at least one rotation element that is located such that it may rotate about a rotation axis, and/or that is provided to generate and/or transfer a rotation moment to a further component and/or element that is rotatable about a rotation axis, it being possible for the rotation element to also include bearing means that rotatably support the rotation element and/or the rotatable component. “Provided” is intended to mean, in particular, specially equipped and/or designed. The inventive design provides an advantageous damping of the auxiliary handle—of the gripping region in particular—and, therefore, a high level of operating comfort for an operator. During operation of the hand-held power tool, a vibration is preferably absorbed by the rotation unit and/or the rotation element via a conversion of vibrational energy into rotational energy, and/or via a deliberate generation of a counter-rotation oriented opposite to an initial oscillation of the hand-held power tool. The inventive auxiliary handle device is basically usable in conjunction with all hand-held power tools that appear reasonable to one skilled in the technical art, thereby making it easier, in particular, for an operator to guide hand-held power tools using the auxiliary handle. Due to its damping property, the auxiliary handle device is particularly advantageous when used with an angle grinder.

It is further provided that the rotation unit includes at least one first rotation element with at least one first rotation axis, and at least one second rotation element with at least one second rotation axis that differs from the first rotation axis, thereby making it possible to attain an advantageous damping of vibrations along different directions of a propagation of vibrations.

When the rotation element is designed as an absorber mass element, it is possible to realize the absorption of vibrations via conversion of vibrational energy into rotational energy, and to advantageously absorb vibrations by generating a counter-vibration that is oriented opposite to an initial vibration of the hand-held power tool. This also makes it possible to increase an inertia of the auxiliary handle device. In this context, an “absorber mass element” refers, in particular, to an element that is excited—at least within one intended frequency range of an initial oscillation and/or excitation oscillation—to generate a counter-oscillation that counteracts the initial or excitation oscillation, and therefore contributes to a reduction of vibrations.

It is also provided that at least two rotation elements are located one after the other along an axial direction of the auxiliary handle, thereby making it possible to dampen vibrations particularly advantageously using the rotation elements along a preferred direction of a transmission of vibrations from the hand-held power tool to the auxiliary handle device. An “axial direction” refers, in particular, to a direction of the auxiliary handle that preferably extends along a length and/or main extension direction of the auxiliary handle.

Particularly preferably, the rotation unit includes—along an axial direction of the auxiliary handle—a varying mass distribution, thereby making it possible to counteract a different vibration behavior of the hand-held power tool in a vibration-damping manner along the axial direction. In this context, a “varying mass distribution” refers, in particular, to a distribution of the mass of the rotation unit, which preferably has different values in three dimensions along a direction, particularly the axial direction.

It is also provided that the rotation element is supported such that it may oscillate in at least one direction, thereby making it possible to advantageously absorb vibrations via a rotation of the rotation element and to further dampen vibrations via a counter-oscillation of the rotation element.

In an advantageous refinement of the present invention, it is provided that the rotation element includes at least one bearing element that is designed to support the rotation element, thereby making it possible to support the rotation element such that it may rotate about the rotation axis, in a wear-reducing manner in particular. A design of the bearing element that provides an elastic suspension of the rotation element, e.g., using an elastomer and/or a coil spring, and/or further spring means that appear reasonable to one skilled in the technical art, are feasible in principle. The bearing element may also be designed as a rotation element.

It is further provided that the bearing element is a damping fluid, thereby making it possible to further absorb vibrational energies during operation of the hand-held power tool. The damping fluid is preferably a pure fluid, a suspension, and/or further damping fluids that appear reasonable to one skilled in the technical art.

When the bearing element is designed as an absorber mass element, it is therefore advantageously possible to attain a vibration-damping counter-oscillation of the absorber mass element relative to an initial vibration of the hand-held power tool that is superposed with a rotational motion of the rotation elements. The bearing element, which is formed by the absorber mass element, may be designed as a bearing cage.

Particularly advantageously, the bearing element is located such that is may rotate about at least one rotation axis, which is designed to be different from at least one rotation axis of at least one rotation element, thereby making it possible for the damping unit to absorb different vibrations produced by the hand-held power tool.

In a further embodiment of the present invention, it is provided that the auxiliary handle device includes a drive unit, which is provided to generate a rotation moment for at least one of the rotation elements. As a result, it is possible to produce a deliberate rotation of the rotation element that counteracts an initial vibration of the hand-held power tool in a particularly profitable manner. A “drive unit” refers, in particular, to a unit that is provided to generate a rotation moment and/or to transfer a rotation moment, e.g., a rotation moment generated by the hand-held power tool, for at least one rotation element.

It is also provided that the auxiliary handle includes a grip sleeve that serves as a receiving area for receiving at least a portion of the damping unit, thereby providing a receiving function with a simple design and making it possible to locate the damping unit inside the auxiliary handle device in a particularly space-saving manner.

When the grip sleeve includes a closing element that is provided to close and open the receiving area, a design that allows a rotation unit and/or a damping unit to be replaced particularly easily may be realized, thereby making it possible to advantageously adapt a damping behavior of the auxiliary handle device to a working process and/or a vibrational behavior of the hand-held power tool.

Further advantages result from the description of the drawing, below. Exemplary embodiments of the present invention are shown in the drawing. The drawing, the description, and the claims contain numerous features in combination. One skilled in the art will also advantageously consider the features individually and combine them to form further reasonable combinations.

### BRIEF DESCRIPTION OF THE DRAWINGS

FIG. 1 shows a hand-held power tool with an inventive auxiliary handle device, in a schematic depiction,

FIG. 2 shows the auxiliary handle device with an inventive damping unit, in a sectional view,

FIG. 3 shows the auxiliary handle device with an alternative rotation unit, and

FIG. 4 shows the auxiliary handle device with an alternative rotation unit, which includes rotation elements supported in oil.

### DESCRIPTION OF THE PREFERRED EMBODIMENTS

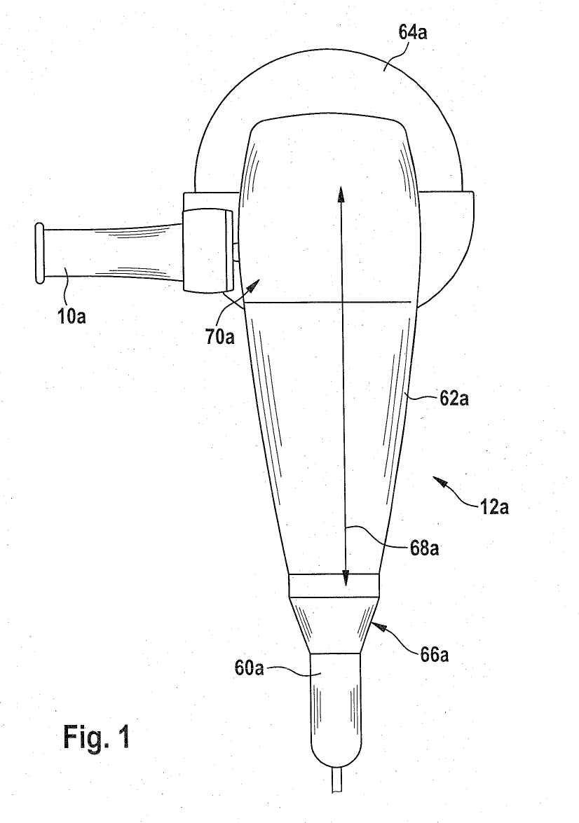

A hand-held power tool 12a designed as an angle grinder is shown in FIG. 1, in a perspective view from above. The angle grinder includes a housing 62a and a main handle 60a integrated in housing 62a. Main handle 60a extends along a side 66a facing away from a tool 64a that is a cutting disk, in a longitudinal direction 68a of the angle grinder. An auxiliary handle device 10a is located in a front region 70a of the angle grinder that is close to the tool, and extends transversely to longitudinal direction 68a of the angle grinder.

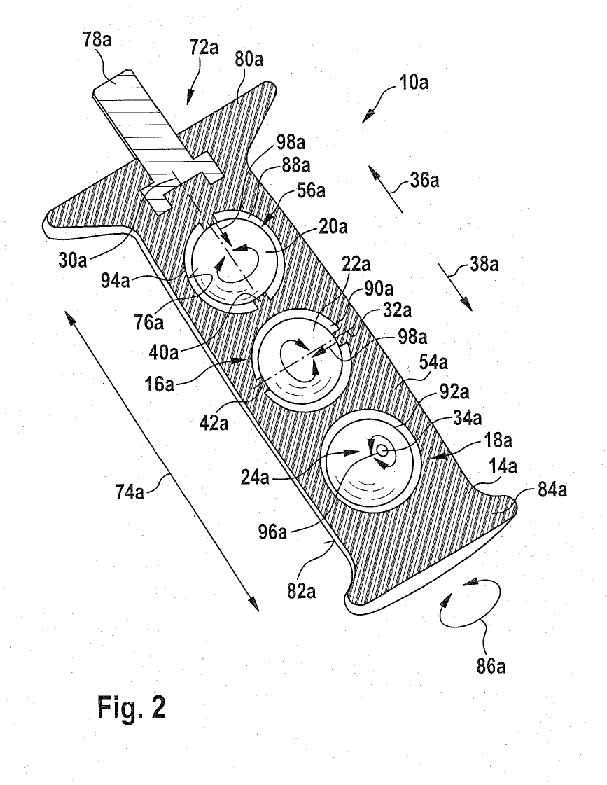

FIG. 2 shows auxiliary handle device 10a with an auxiliary handle 14a, a fastening unit 72a, and a damping unit 16a. Additional handle 14a includes a grip sleeve 54a, which extends along a main extension direction 74a of auxiliary handle device 10a. Grip sleeve 54a forms—together with a radially inwardly facing surface 76a—a receiving area 56a, which is provided to receive damping unit 16a. Receiving area 56a is designed cylindrical in shape along main extension direction 74a. Fastening unit 72a, which is designed to be screwed together with hand-held power tool 12a, includes a bolt-shaped fastening element 78a designed as a screw element that is non-rotatably mounted on end region 80a of auxiliary handle 14a in main extension direction 74a via a bonded, non-positive, and/or form-fit connection.

Auxiliary handle 14a and/or grip sleeve 54a has a surface 82a that is curved radially outwardly along main extension direction 74a of auxiliary handle 14a, thereby providing a particulary good grip for an operator of auxiliary handle device 10a. A ridge-type raised area is provided along main extension direction 74a in end regions 80a, 84a of grip sleeve 54a, which limits a gripping region of grip sleeve 54a for an operator of auxiliary handle device 10a along main extension direction 74a. The two ridge-type raised areas are located on auxiliary handle 14a in the manner of rings, in a circumferential direction 86a, which extends perpendicularly to main extension direction 74a. The two ridge-type raised areas extend radially outwardly from auxiliary handle 14a. During operation of auxiliary handle device 10a, ridge-type raised areas prevent the operator's hand from slipping when the operator guides hand-held power tool 12a using auxiliary handle device 10a and/or while force is being transmitted by the operator via auxiliary handle device 10a to hand-held power tool 12a.

Damping element 16a includes a rotation unit 18a with three rotation elements 20a, 22a, 24a. The three rotation elements 20a, 22a, 24a are designed as spherical absorber mass elements and have different masses. A rotation axis 30a, 32a, 34a of one of the rotation elements 20a, 22a, 24a is oriented essentially perpendicularly to one of the rotation axes 30a, 32a, 34a of the other two rotation elements 20a, 22a, 24a. Rotation axis 30a of first rotation element 20a is oriented essentially parallel to main extension direction 74a of auxiliary handle 14a. Rotation elements 20a, 22a, 24a are located one after the other along main extension direction 74a and/or an axial direction 36a, 38a of auxiliary handle 14a, inside receiving area 56a of grip sleeve 54. A subregion of grip sleeve 54a that faces rotation unit 18a and/or rotation elements 20a, 22a, 24a is designed as a cage for receiving rotation elements 20a, 22a, 24a. To this end, receiving area 56a includes three spherical recesses 88a, 90a, 92a, each of which receives one of the spherical rotation elements 20a, 22a, 24a.

Inside spherical recesses 88a, 90a, 92a, each rotation unit 18a includes a bearing element 40a, 42a, which is provided to support particular rotation element 20a, 22a, 24a such that it may rotate about rotation axis 30a, 32a, 34a. Rotation elements 20a, 22a, 24a are supported such that they may rotate in both directions about rotation axis 30a, 32a, 34a. It is basically feasible that rotation elements 20a, 22a, 24a may rotate in only one direction around rotation axis 30a, 32a, 34a, e.g., using a one-way clutch. Bearing elements 40a, 42a are designed a peg-shaped elements located on the radially inwardly oriented surface 76a of a jacket 94a of spherical recesses 88a, 90a, 92a. In addition, bearing elements 40a, 42a extend along particular rotation axis 30a, 32a, 34a of rotation elements 20a, 22a, 24a from jacket 94a in a radial direction 98a of spherical recess 88a, 90a, 92a, partially inwardly toward a center point of spherical recess 88a, 90a, 92a. Two bearing elements 40a, 42a are always located on opposite sides of jacket 94a. It is also basically feasible for bearing elements 40a, 42a to be located such that they are preloaded against a spring element, e.g., against a coil spring and/or an elastomer. Rotation elements 20a, 22a, 24a have cylindrical recesses 96a for receiving bearing elements 40a, 42a.

Cylindrical recesses 96a extend into rotation elements 20a, 22a, 24a in a radial direction 98a, cylindrical recesses 96a being restricted to an outer edge region of rotation elements 20a, 22a, 24a, so that rotation elements 20a, 22a, 24a are located along particular rotation axis 30a, 32a, 34a equidistantly from jacket 94a of recess 88a, 90a, 92a, thereby ensuring that rotation elements 20a, 22a, 24a may rotate during operation of hand-held power tool 12a. It is also basically feasible for rotation elements 20a, 22a, 24a to be supported inside receiving area 56a and/or inside spherical recesses 88a, 90a, 92a in a damping fluid, e.g., an oil, etc., to provide additional vibration damping.

When hand-held power tool 12a is operated together with auxiliary handle device 10a, vibrations are transmitted from hand-held power tool 12a to auxiliary handle device 10a and/or via fastening unit 72a to auxiliary handle 14a. The vibrations are damped and/or a vibrational energy of the vibrations is absorbed via damping unit 16a and/or rotation unit 18a in that rotation elements 20a, 22a, 24a convert the vibrational energy into a rotational energy. It is also basically feasible for damping unit 16a to include a drive unit that deliberately excites individual rotation elements 20a, 22a, 24a to rotate opposite to the vibrations produced by hand-held power tool 12a. A damping behavior of damping unit 16a may be adapted to a vibrational behavior, in particular to a frequency of oscillation of hand-held power tool 12a, by providing a differing distribution of mass along axial direction 36a, 38a and/or by designing individual rotation elements 20a, 22a, 24a with different masses. It is also basically feasible, however, for rotation elements 20a, 22a, 24a to have identical masses.

It is also basically feasible for damping unit 16a—together with a subregion that encloses spherical recesses 88a, 90a, 92a—to be installed such that it may be replaced within receiving area 56a of grip sleeve 54a. As a result, by swapping-out different damping units 16a, it is advantageously possible to adapt a damping property of auxiliary handle device 10a to a vibration property of hand-held power tool 12a.

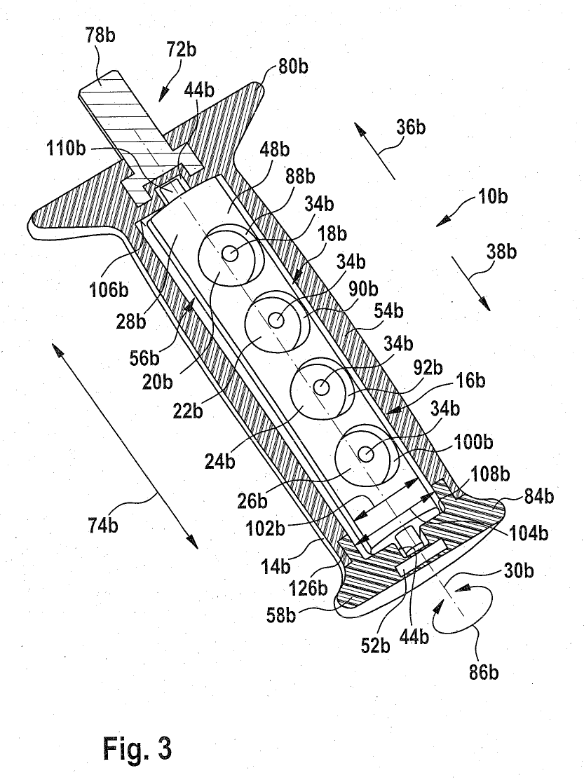

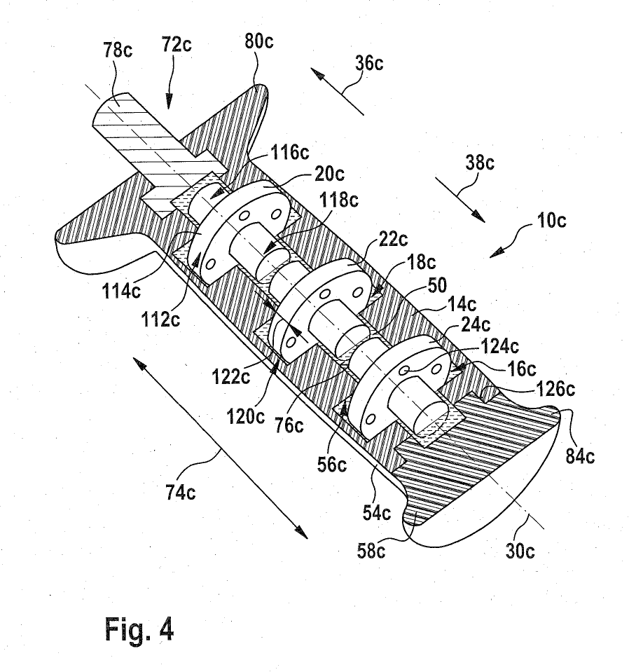

Alternative exemplary embodiments are shown in FIGS. 3 and 4. Components, features, and functions that are essentially the same are labelled with the same reference numerals. To distinguish the exemplary embodiments from each other, the reference numerals of the exemplary embodiments are appended with the letters a through c. The description below is essentially limited to the differences from the exemplary embodiment in FIGS. 1 and 2. With regard for the components, features, and functions that remain the same, reference is made to the description of the exemplary embodiment in FIGS. 1 and 2.

FIG. 3 shows an alternative auxiliary handle device 10b with an alternative rotation unit 18b. Rotation unit 18b includes four spherical rotation elements 20b, 22b, 24b, 26b, which are designed as absorber mass elements and are located inside a fifth rotation element 28b, which is also designed as an absorber mass element. Fifth rotation element 28b is cylindrical in design and is also provided to serve as bearing element 48b for supporting spherical rotation elements 20b, 22b, 24b, 26b. To this end, cylindrical rotation element 28b includes four spherical recesses 88b, 90b, 92b, 100b, which are located one after the other along an axial direction 36b, 38b inside cylindrical rotation element 28b. Each of the spherical rotation elements 20b, 22b, 24b, 26b is located in one of the four spherical recesses 88b, 90b, 92b, 100b, and they are supported via bearing elements (as shown in FIG. 2) such that they may rotate about a rotation axis 34b. Rotation axes 34b of spherical rotation elements 20b, 22b, 24b, 26b are oriented parallel to each other and perpendicular to axial direction 36b, 38b, the individual spherical rotation elements 20b, 22b, 24b, 26b rotating around rotation axes 34b in directions opposite to each other.

Cylindrical rotation element 28b extends essentially parallel to main extension direction 74b of auxiliary handle 14b. A diameter 102b of rotation element 28b is smaller than a diameter 104b of receiving area 56b, so that rotation element 28b is located inside receiving area 56b such that it may rotate about a rotation axis 30b that extends parallel to axial direction 36b, 38b. To support cylindrical rotation element 28b, receiving area 56b includes bearing elements 44b, each of which is designed as a cylindrical recess. Bearing elements 44b are located in axial direction 36b, 38b on opposite surfaces 106b, 108b of receiving area 56b, and they are designed to each receive a cylindrical, peg-shaped element 110b with a smaller diameter than that of rotation element 28b. On a side of receiving area 56b facing away from a fastening unit 72b, receiving area 56b and/or grip sleeve 54b includes a closing element 58b, via which receiving area 56b may be closed and/or opened using a thread 126b. Rotation unit 18b is therefore located inside auxiliary handle device 10b such that it may be swapped out by an operator of auxiliary handle device 10b. Rotation unit 18b also includes a drive unit 52b, which is located inside closing element 58b. A rotation moment is generated via drive unit 52b during operation, the rotation moment driving cylindrical rotation element 28b to rotate about rotation axis 30b. To this end, drive unit 52b includes a motor and an energy-storing means, neither of which is shown here.

FIG. 4 shows an alternative auxiliary handle device 10c with an alternative rotation unit 18c. Rotation unit 18c includes three rotation elements 20c, 22c, 24c, which are designed as absorber mass elements, and which are located inside a receiving area 56c of an auxiliary handle 14c of auxiliary handle device 10c. Rotation elements 20c, 22c, 24c are designed cylindrical in shape in an axial direction 36c, 38c of auxiliary handle 14c and include a disk-shaped projection 114c in a central subregion 112c along axial direction 36c, 38c. Disk-shaped projection 114c has a larger diameter than cylindrical subregions 116c, 118c of rotation elements 20c, 22c, 24c adjacent thereto in axial direction 36c, 38c. The three rotation elements 20c, 22c, 24c are located one after the other in axial direction 36c, 38c inside receiving area 56c. To receive rotation elements 20c, 22c, 24c, a radially inwardly oriented surface 76c of a grip sleeve 54c of auxiliary handle 14c is provided with a castellations, and a subregion 120c of receiving area 56c for receiving disk-shaped projection 114c is longer in axial direction 36c, 38c than a length 122c of disk-shaped projection 114c, thereby enabling rotation elements 20c, 22c, 24c to oscillate in axial direction 36c, 38c.

Inside receiving area 56c, rotation elements 20c, 22c, 24c are supported in a bearing element 50c, which is a damping fluid. To dampen vibrations, rotation elements 20c, 22c, 24c are excited to rotate about a rotation axis 30c, which extends parallel to axial direction 36c, 38c of auxiliary handle 14c, and they are excited to perform a counter-oscillation in axial direction 36c, 38c. To support a damping effect, disk-shaped projections 114c of rotation elements 20c, 22c, 24c include cylindrical recesses 124c that are open in a direction of oscillation and/or axial direction 36c, 38c, through which the damping fluid may flow when counter-oscillations occur. On an end region 84c of grip sleeve 54c facing away from a fastening unit 72c, grip sleeve 54c includes a closing element 58c with a thread 126c, via which receiving area 56c may be closed or opened. As a result, rotation elements 20c, 22c, 24c and/or the damping fluid are located inside auxiliary handle device 10c such that they may be replaced by an operator. It is also feasible for rotation elements 20c, 22c, 24c to be driveable using a drive unit, e.g., a motor, to produce an active counter-oscillation when hand-held power tool 12c is operated together with auxiliary handle device 14c.

It will be understood that each of the elements described above, or two or more together, may also find a useful application in other types of constructions differing from the types described above.

While the invention has been illustrated and described as embodied in an auxiliary handle device, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. An auxiliary handle device, comprising an auxiliary handle; a damping unit, said damping unit including a rotation unit with at least one rotation: element which is configured to rotate about at least one rotation axis.

2. An auxiliary handle device as defined in claim 1, wherein said rotation unit includes at least one first rotation element with at least one first rotation axis, and at least one second rotation element with at least one second rotation axis that is different from said first rotation axis.

3. An auxiliary handle device as defined in claim 1, wherein said rotation element is an absorber mass element.

4. An auxiliary handle device as defined in claim 1, and further comprising a second such rotation element, so that there are at least two rotation elements located one after the other along an axial direction of said auxiliary handle.

5. An auxiliary handle device as defined in claim 1, wherein said rotation unit has a varying mass distribution along an axial direction of said auxiliary handle.

6. An auxiliary handle device as defined in claim 1, wherein said rotation element is supported such that it is oscillatable in at least one direction.

7. An auxiliary handle device as defined in claim 1, wherein said rotation unit includes at least one bearing element configured to support said rotation element.

8. An auxiliary handle device as defined in claim 7, wherein said bearing element is configured as a damping fluid.

9. An auxiliary handle device as defined in claim 7, wherein said bearing element is configured as an absorber mass element.

10. An auxiliary handle device as defined in claim 7, wherein said bearing element is located such that it is rotatable about at least one rotation axis which is different from said at least one rotation axis of said at least one rotation element.

11. An auxiliary handle device as defined in claim 1, wherein said rotation unit has at least one rotation element; and further comprising a drive unit provided for producing a rotation moment for said at least one rotation element.

12. An auxiliary handle device as defined in claim 1, wherein said auxiliary handle includes a grip sleeve with at least a portion having a receiving area for said rotation unit.

13. An auxiliary handle device as defined in claim 12, wherein said grip sleeve includes a closing element for closing and opening said receiving area.

14. A hand-held power tool, comprising a main handle; and an auxiliary handle device including an auxiliary handle; and a damping unit, said damping unit including a rotation unit with at least one rotation element which is configured to rotate about at least one rotation axis.

15. A hand-held power tool as defined in claim 14, wherein the hand-held power tool is configured as an angle grinder.
